(19) United States
(12) Patent Application Publication
(10) Pub. No.: US 2020/0163320 A1
(43) Pub. Date: May 28, 2020

(54) ICE FISHING HOLE COVER

(71) Applicant: Derick Lee Tibbetts, Elk River, MN (US)

(72) Inventor: Derick Lee Tibbetts, Elk River, MN (US)

(21) Appl. No.: 16/419,653

(22) Filed: May 22, 2019

Related U.S. Application Data
(60) Provisional application No. 62/772,362, filed on Nov. 28, 2018.

(51) Int. Cl. A01K 97/01

(52) U.S. Cl. CPC A01K 97/01

(57) ABSTRACT

A Portable Ice Fishing Hole Cover. The Ice Cap has a sleeve that is configured to be received in the open ice hole. A base keeps the cover in place and is strong enough to withstand weight bearing on the lid covering the open hole. The cover also allows an angler to actively fish with the lid shut preventing objects, pets, or people from falling into the hole.

### CROSS-REFERENCE TO RELATED APPLICATION

This application claims the benefit of priority of U.S. provisional application No. 62/772,362, filed Nov. 28, 2018, the contents of which are herein incorporated by reference.

### BACKGROUND OF THE INVENTION

The present invention relates ice fishing, and more particularly to an apparatus for covering a hole in the ice through which to fish.

Ice fishing hole covers are typically only utilized for fixed/hard ice houses. While there are covers that go over holes, they can be stepped on and broken causing people to fall into the open hole. For example, foam covers aren't strong enough to allow anyone to stand on. Likewise, a plastic cover, with on securement with the ice hole is easily kicked out of the way and does not stay stationary.

As can be seen, there is a need for an improved ice fishing hole cover.

### SUMMARY OF THE INVENTION

In one aspect of the present invention a cover for an ice fishing hole is disclosed. The cover includes a cylindrical sleeve having a top opening, a bottom opening, and an interior bore. The cylindrical sleeve is dimensioned to be received within a bore of the ice fishing hole. A base surrounding the top opening is dimensioned to be substantially larger than the bore of the ice fishing hole. A lid is attached to the base via a hinge proximal to the top opening. The lid is operable between an open position and a closed position.

In some embodiments, a slot is defined in the lid and extends radially inwardly from a side of the lid opposite the hinge.

In some embodiments, the base has a frusto-conical shape diverging outwardly from the top opening. In other embodiments, the base is formed as a spheroidal section.

In other embodiments, one or more handles are defined in a surface of the base.

In other embodiments, a plurality of apertures are defined in a top surface of the base. The apertures are dimensioned to receive a stake for securing the cover to the surface of the ice.

In yet other embodiments, an annular rim may be defined about the top opening and recessed from a top surface of the base. The lid is dimensioned to be supported on the annular rim.

The cylindrical sleeve is frusto-conical, and converges inwardly from the top opening to the bottom opening.

In other aspects of the invention, a cover for an ice fishing hole includes a cylindrical sleeve having a top opening, a bottom opening and an interior bore. The cylindrical sleeve is dimensioned to be received within a bore of the ice fishing hole. A base surrounds the top of the sleeve and is dimensioned to support the cover on a surface of the ice surrounding the bore. A lid is hingedly attached to the base, and is operable between an open position and a closed position.

These and other features, aspects and advantages of the present invention will become better understood with reference to the following drawings, description and claims.

### BRIEF DESCRIPTION OF THE DRAWINGS

FIG. 1 is a top plan view of the ice fishing cover, with the lid in an open position;

FIG. 2 is a perspective view of the ice fishing cover with the lid closed;

FIG. 3 is a front view of the ice fishing cover;

FIG. 4 is a perspective view of the ice fishing cover with the lid open;

FIG. 5 is a perspective view of the lid;

FIG. 6 is a perspective view ice fishing cover without the lid; and

FIG. 7 is a cross-section view of the ice fishing cover.

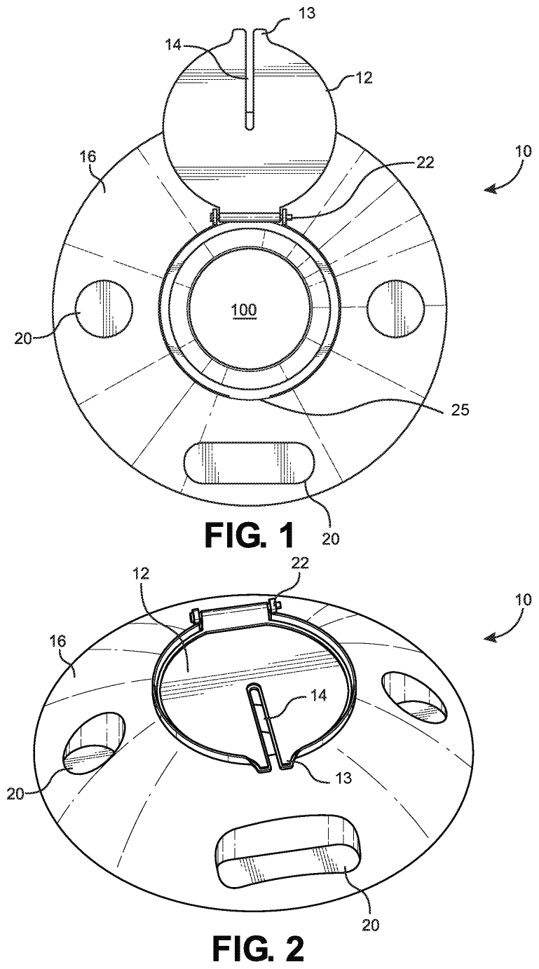

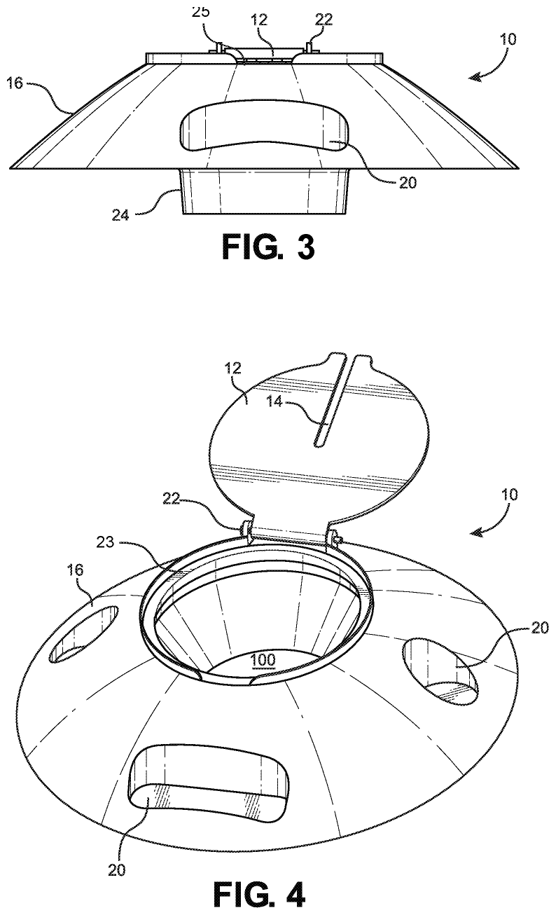

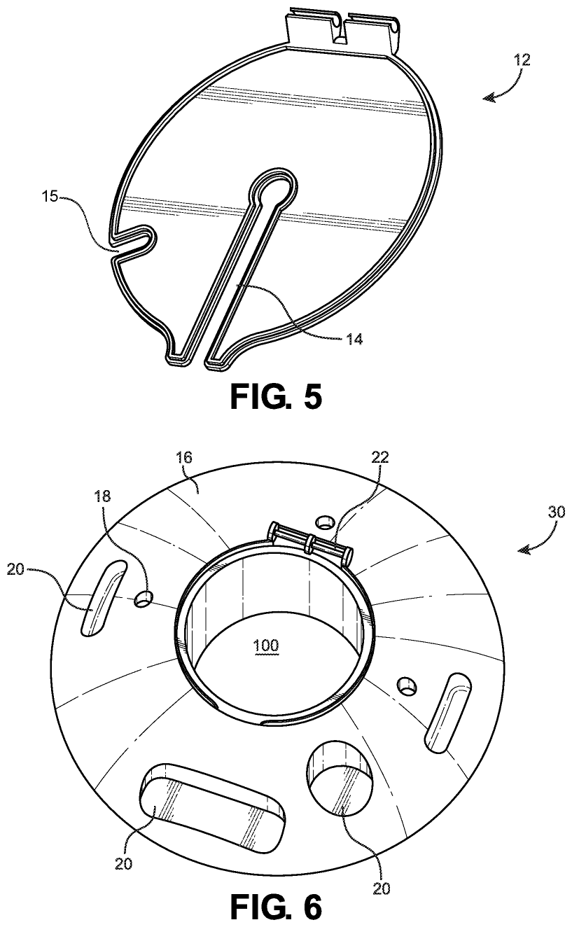

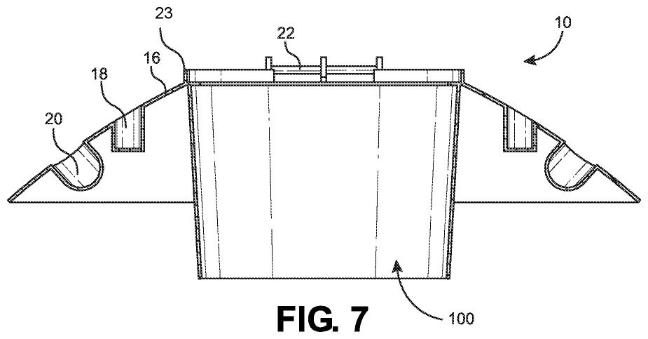

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an apparatus and method for protecting an ice fishing hole. The ice fishing cover 10 according to embodiments of the invention, has a frusto-conical cylindrical sleeve 24 with a lower end that that is dimensioned to be received within a bore formed in the surface of the ice through which to fish. The frusto-conical sleeve 24 has an annular rim 23 defined about a top end of the sleeve 24. The sleeve 24 converges slightly from the top end to the bottom end. The converging sidewalls of the frusto-conical sleeve 24 permits the sleeve to be fitted into the ice hole with an interference fit. The sleeve 24 will preferably have a length of about 4″ below the base to provide for a deep insertion into the ice to facilitate retention of the cap 10 in the ice and disturbing the sidewalls of the ice bore when retrieving fish and tackle.

A hole cover base 16 may likewise be formed as a frusto-conical, or spheroidal section, having a slighter angle than that of the sleeve 24. The base 16 has a central opening that is dimensioned to receive the sleeve 24. The annular rim 23 may be supported by a shoulder of the central opening 100. The base 16, with the sleeve 24 protruding through a bottom end of the base 16, keeps the cover 10 in place within the hole and is strong enough to withstand weight bearing on the cover 10 covering the open hole in the ice.

A bottom surface of the base 16 supports the cover 10 on the ice surface surrounding the hole. The frusto-conical or spheroidal shape of the base 16 is substantially elevated above the surface of the ice, preferably about 2″, in order to deflect items away from the hole. Likewise, the frusto-conical or spheroidal shape of the base 16 serves to strengthen the base and distribute forces around the hole in the ice in the event the cover 10 is stepped on so as to prevent fracturing of the ice due to point loading.

The cover 10 includes a lid 12 that is hingedly operable about a pivot pin 22 between an open position and a closed position. In the closed position, the lid 12 is supported by a top surface of the annular rim 23. The lid 12 also has a line slot 14 defined therein that allows an angler to actively fish with the lid 12 shut preventing objects, pets, or people from falling into the hole. The lid 12 also provides protection of the bore from the elements to prevent bore from refreezing. The line slot 14 extends from an edge opposite the hinged connection to permit operation of the lid 12 without disturbing the fishing line.

The base 16 may also include a plurality of handles 20, or grip depressions, used to place and remove the ice cap 10. The handles 20, may include one or more indentations or finger slots, defined in a surface of the base 16 to permit gripping of the base 16. The base 16 may also include one or more apertures 18 to receive a stake to secure the cap 10 to the ice. The handles 20 or apertures 18 in the base 16 may provide a mounting point for a signal apparatus, or tipping device, to signal that the angler has caught a fish on the line.

In some embodiments, the ice cap 10 sleeve 24 fits into a pre drilled ice hole formed for ice fishing. The lid 12 attaches to the base 16 and is operable between an open and a closed position. The angler is able to fish through the lid 12 through the ¼″ slotted opening 14 in the lid 12. The placement of the slot 14 in the lid 12 allows the lid 12 to be opened and closed when fishing, permitting the angler to retrieve a fish through the ice cap 10. The fishing line will pass through the slotted opening 14 in the lid 12, to permit the lid 12 to be closed, to prevent the loss of keys, tackle, bait, or other objects that may fall into the otherwise open hole. The lid 12 may also include a second slot 15 defined in a periphery of the lid 12. The second slot 15 provides for passage of an electrical cable or tether for one or more electronic devices or sensors, such as a fish finder, sonar, or the like. The lid 12 may also provide sufficient protection from the cold to prevent freezing of the hole.

The base 16 and sleeve 24 may be injection molded using a plastic/rubber combination. The lid 12 will fit into a pre-molded hinge 22 and attach to the base 16. A hinge attachment tab 25 provides an offset from the hinge 22 to permit the lid 12 to be lowered to and be supported by the annular rim 23. A cutout 25 may be defined in the base 16 opposite the hinge 22. The cutout 25 is dimensioned to receive a lift tab 13 extending from at least one side of the slot 14. The lift tab 13 protrudes from the cutout 25 so that the lid 12 may be lifted, and preferably has a sufficient protrusion to be operated by a gloved hand of the fisherman.

In use, the ice angler will place the ice cap 10 with the sleeve 24 extending into the open ice fishing hole. The sleeve 24 will slide into the pre-cut opening in the ice. The ice hole will thus be covered and safe from dropping objects into the hole, pets/humans from stepping into the hole and into the water.

It should be understood, of course, that the foregoing relates to exemplary embodiments of the invention and that modifications may be made without departing from the spirit and scope of the invention.

What is claimed is:

1. A cover for an ice fishing hole, comprising:
a cylindrical sleeve having a top opening and a bottom opening and an interior bore, the cylindrical sleeve dimensioned to be received within a bore of the ice fishing hole;
a base surrounding the top opening and dimensioned to be substantially larger than the bore of the ice fishing hole; and
a lid attached to the base via a hinge proximal to the top opening, the lid operable between an open position and a closed position.

2. The cover of claim 1, further comprising:
a slot defined in the lid and extending radially inwardly from a side of the lid opposite the hinge.

3. The cover of claim 1, wherein the base has a frusto-conical shape diverging outwardly from the top opening.

4. The cover of claim 1, wherein the base is formed as a spheroidal section.

5. The cover of claim 1, further comprising:
one or more handles defined in a surface of the base.

6. The cover of claim 1, further comprising:
a plurality of apertures defined in a top surface of the base, the apertures dimensioned to receive a stake for securing the cover to the surface of the ice.

7. The cover of claim 1, further comprising:
an annular rim defined about the top opening and recessed from a top surface of the base.

8. The cover of claim 7, wherein the lid is dimensioned to be supported on the annular rim.

9. The cover of claim 1, wherein the cylindrical sleeve is frusto-conical, and converges inwardly from the top opening to the bottom opening.

10. A cover for an ice fishing hole, comprising:
a cylindrical sleeve having a top opening, a bottom opening and an interior bore, the cylindrical sleeve dimensioned to be received within a bore of the ice fishing hole;
a base surrounding the top of the sleeve, the base dimensioned to support the cover on a surface of the ice surrounding the bore; and
a lid attached to the base, the lid operable between an open position and a closed position.
